(19) United States
(12) Patent Application Publication
(10) Pub. No.: US 2026/0316608 A1
(43) Pub. Date: Oct. 15, 2026

(54) INVERTED PANTOGRAPH FOR A CHARGING DEVICE FOR ELECTRIC VEHICLES

(71) Applicant: Siemens Aktiengesellschaft, München (DE)

(72) Inventors: Holger Schererz, Rehfelde (DE); Artur Wenkler, Berlin (DE)

(21) Appl. No.: 18/880,726

(22) PCT Filed: Jun. 29, 2023
(86) PCT No.: PCT/EP2023/067936

§ 371 Date: Jan. 2, 2025

(30) Foreign Application Priority Data
Jul. 1, 2022 (DE) 10 2022 206 751.7

(51) Int. Cl. B60L 5/24; B60L 5/30; B60L 53/14; B60L 53/35; B60L 53/60

(52) U.S. Cl. CPC B60L 5/24; B60L 5/30; B60L 53/14; B60L 53/35; B60L 53/60

(57) ABSTRACT

An inverted pantograph for a charging device for electric vehicles includes an actuator having a suspension device at a first end and a contact head, for contacting the electric vehicle, at a second opposite end. The suspension device serves for mounting on a supporting structure such as a mast or a hall ceiling. The actuator is configured to lower the contact head from a rest position into a charging position and to exert a pressing force on the contact head in the charging position to charge the electric vehicle, and to raise the contact head into the rest position after a charging process. The actuator includes a telescopic shaft which has at least two sub-shafts, which are axially slidable one into the other. A charging device having the inverted pantograph is also provided.

### TECHNICAL FIELD

The invention relates to an inverted pantograph for a charging device for electric vehicles and to a charging device with such an inverted pantograph.

### TECHNICAL BACKGROUND

The charging of electric commercial vehicles such as buses or trucks can, on the one hand, take place with the aid of a cable/plug in a similar fashion to a car. This is, however, problematic because direct human interaction is usually required for this, which is generally excluded in particular in the case of so-called opportunity charging as when charging at a bus stop during scheduled service whilst passengers are getting on and off. In order to automate this process, such vehicles are therefore preferably charged with external current transmitters. For this purpose, exposed or automatedly exposable contacts are situated on the roof of the vehicles. With the aid of a contact device which is lowered and connected to the charging device, contact for the charging is established such that the vehicle is contacted from above and beyond the reach of people.

In known applications, a conventional current collector from railroad vehicle engineering (a pantograph), which has been mounted upside down (an inverted pantograph), is used as the current transmitter. In contrast to the application to railroad vehicles, the contact between the charging device and the vehicle is established on the power supply side by the inverted pantograph being lowered from above down onto the electric vehicle. In the case of certain inverted pantographs from the prior art, it executes a pivoting movement such that both lowering and a lateral movement are performed in a rotational movement.

In order to make a charging device provided with an inverted pantograph usable for vehicles of different heights such as single-decker and double-decker buses, a large working stroke of the inverted pantograph is desirable.

The object of the invention is therefore to provide an improved inverted pantograph and an improved charging device for electric vehicles.

The invention achieves this object by an inverted pantograph according to claim 1 and a charging device according to claim 10. Advantageous embodiments of the invention form the subject matter of the dependent claims.

### SUMMARY OF THE INVENTION

A first aspect of the invention introduces an improved inverted pantograph for a charging device for an electric vehicle. The inverted pantograph has an actuator which has a suspension means at a first end and a contact head for contacting the electric vehicle at a second end opposite the first end. The suspension means here serves for fastening to a support structure such as a mast or a hall ceiling. The actuator is for this purpose designed, for the purpose of charging the electric vehicle, to lower the contact head from a rest position into a charging position and, in the charging position, to exert a contact pressure on the contact head, and to raise the contact head into the rest position after a charging procedure. According to the invention, the actuator comprises a telescopic shaft which has at least two sub-shafts which can be pushed axially into each other.

The inverted pantograph according to the invention allows a large working stroke but, because of the use of the telescopic shaft, does not require a lot of free space as there is no need, as in the prior art, for a holding shaft with the contact head to be positioned in the space above the rest position of the contact head or pivoted away to the side, which correspondingly uses a lot of space. As a result, the inverted pantograph according to the invention allows, with a consistent working stroke, for example a lower ceiling height (logistics depot, bus station, etc.) and avoids lateral pivoting of the contact head, which requires corresponding obstacle-free and protected space to the side of the inverted pantograph.

Where directional specifications and relationships such as “lateral”, “above”, “lower”, “raise”, etc. are used here, they refer to a device installed in operational condition.

The contact pressure is particularly preferably effected by a weight force of the contact head and at least one sub-shaft of the telescopic shaft. In other words, the contact pressure here has no force component in the direction of the contact pressure other than the weight force of the contact head and at least one sub-10 shaft of the telescopic shaft. In this configuration, a defined contact pressure can be effected in a simple fashion without it being necessary for the contact pressure to be measured and possibly a motor or the like regulated for this purpose. It is also possible by virtue of this simple measure to maintain a consistent contact pressure even when the contact height changes after contact has been established because the electric vehicle has been lowered in order to make it easier for passengers to get off and on or for goods to be loaded and unloaded (often referred to as “kneeling”).

The contact pressure can, however, here be the result of many forces which are exerted. In particular, the contact pressure can be a difference in the weight force of the contact head and the at least one sub-shaft of the telescopic shaft, and a counter force. The counter force can be, for example, a restoring force which is increased for raising the contact head into the rest position after a charging procedure has ended.

The actuator can comprise a control unit and a cable drive, connected to the contact head, which is designed to move the contact head, in response to control signals of the control unit, between the rest position and the charging position. The use of a cable drive allows the transmission of force to be redirected to the side and hence an arrangement with a small height. It is intended here that a “cable drive” is to be understood not necessarily as a drive using a cable and of course force transmission means with the same effect, such as chains, belts, and the like, can also be employed. The cable drive preferably has an electric motor.

The contact head is particularly preferably connected to the telescopic shaft via a spring-loaded bearing. The inverted pantograph here has a first sensor which is designed to measure a first measured value dependent on a force acting on the spring-loaded bearing and to output it to the control unit as a first measurement signal. The control unit is moreover here designed to stop the cable drive when the first measurement signal exceeds a predetermined first threshold value. This makes it possible to lower the contact head in a controlled fashion until the first sensor indicates that the contact head is sitting on the mating contacts of the electric vehicle such that the force acting on the spring-loaded bearing exceeds the first threshold value. More complex measures for position and distance recognition can consequently be omitted.

In the case of designs of the inverted pantograph with a cable drive, a second sensor can be provided which is designed to measure a second measured value dependent on a tensile force acting on the cable drive and to output it to the control unit as a second measurement signal. The control unit is then moreover designed to stop the cable drive when the second measurement signal exceeds a predetermined second threshold value. As a result, tearing of the cable (chain, belt, etc., see above) is prevented if the contact head has jammed or another mechanical problem occurs when raising the contact head.

An energy accumulator connected to the control unit and the cable drive can also be provided. In this case, the control unit is additionally designed to detect failure of a supply voltage and, when failure of the supply voltage is detected, to output a restoring control signal to the cable drive. The cable drive is here designed to raise the contact head into the rest position in response to the restoring control signal. The energy accumulator can be, for example, an electrical or electrochemical accumulator but also a spring-loaded accumulator or a comparable mechanical accumulator. The energy accumulator ensures that the contact head can be raised into the secure rest position and hence outside the area within the reach of people and machines in spite of a serious operating fault.

A second aspect of the invention relates to a charging device for charging an electric vehicle, wherein the charging device has an inverted pantograph according to the first aspect of the invention.

### BRIEF DESCRIPTION OF THE DRAWINGS

The invention is described in detail below on the basis of drawings of exemplary embodiments, in which:

FIG. 1 shows an exemplary embodiment of an inverted pantograph according to the invention in a rest position;

FIG. 2 shows the exemplary embodiment of the inverted pantograph according to the invention in a charging position;

FIG. 3 shows a further exemplary embodiment of an inverted pantograph according to the invention; and

FIG. 4 shows a third exemplary embodiment of an inverted pantograph according to the invention.

### DETAILED DESCRIPTION OF THE DRAWINGS

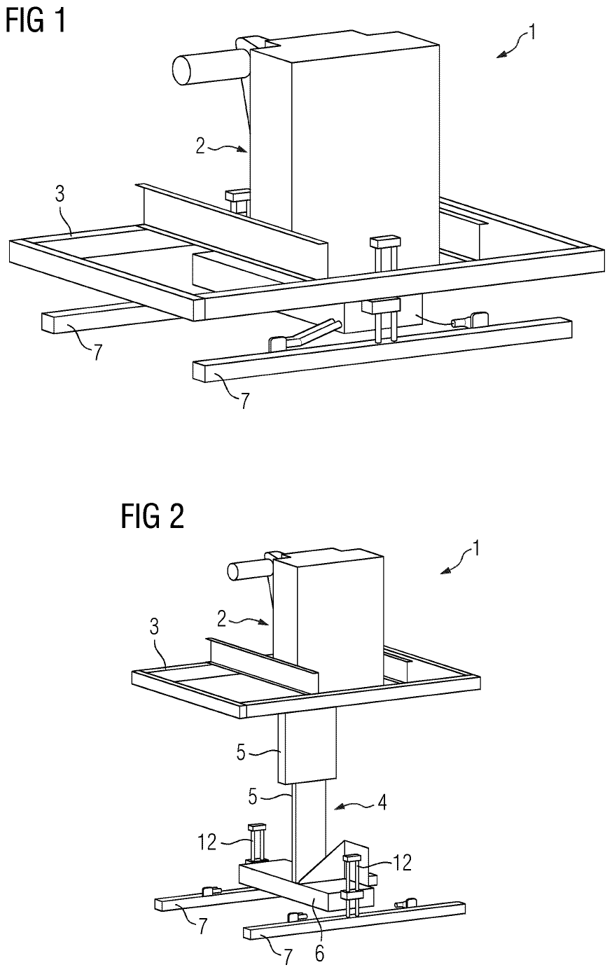

FIG. 1 shows an exemplary embodiment of an inverted pantograph 1 according to the invention in a rest position. The inverted pantograph 1 has an actuator 2 which is provided to lower a contact head 6, arranged at one end of the actuator 2 (the lower end of the actuator 2 in normal operation), from the illustrated rest position into a charging position. The contact head 6 serves to establish, via contact rails 7, electrical contacts with a mating contact arrangement arranged on the roof of an electric vehicle. For this purpose, the contact head 6 is lowered onto the mating contact arrangement and pressed onto the mating contact arrangement by the action of the force of gravity of the contact head 6 and parts of the actuator 2 which are connected thereto.

The other end (the upper end during normal use) of the actuator 2 is connected to a suspension means 3 which serves to connect the actuator 2 to a hall ceiling, a holding bridge, a mast positioned to one side, or the like. In the exemplary embodiment shown, the actuator 2 here projects partially upward above the suspension means 3. However, depending on the location where it is deployed, any suitable relative arrangements of that end of the actuator 2 which is connected to the suspension means 3, and of the suspension means 3, can be provided. Within the scope of the invention, attachment of the suspension means at a different end of the actuator 2 from the end at which the contact head 6 is arranged is considered to have been implemented when activation of the actuator 2 during normal operation changes the relative vertical distance between the suspension means 3 and the contact head 6.

FIG. 2 shows the exemplary embodiment of the inverted pantograph 1 according to the invention in FIG. 1 in a charging position. In the charging position, the contact head 6 is lowered compared with the rest position such that an electric vehicle positioned below the inverted pantograph 1 is contacted for a charging procedure. In the charging position, the actuator 2 is extended compared with the rest position in order to overcome the difference in height between the two positions. Consequently, a telescopic shaft 4 provided according to the invention can be seen in FIG. 2 which comprises at least two (precisely two in the exemplary embodiment shown) sub-shafts 5 which can be pushed axially into each other. The number of sub-shafts 5 can be increased in order to increase the difference in height between the rest position and charging position relative to the total height of the inverted pantograph 1 in the rest position.

In the exemplary embodiment in FIGS. 1 and 2, spring-loaded bearings 12 are also provided which connect a base of the contact head 6 to the contact rails 7 such that the contact rails 7 are mounted resiliently on the base. This enables a certain height compensation if the electric vehicle positioned below the inverted pantograph 1 is not oriented precisely horizontally.

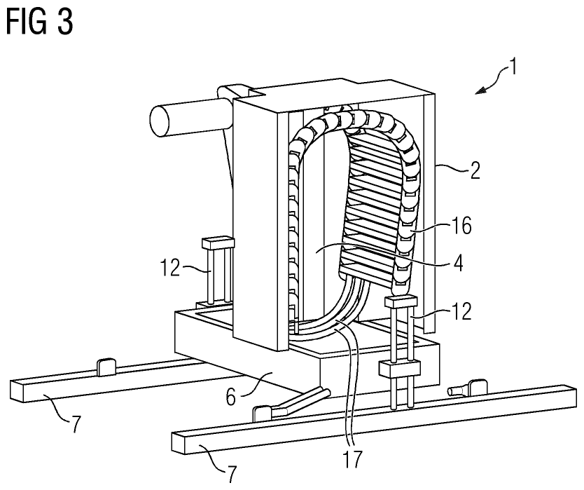

FIG. 3 shows a further exemplary embodiment of an inverted pantograph 1 according to the invention, wherein the inverted pantograph is illustrated in the rest position. The objects designated with the same reference signs designate the same or similar objects as have been explained in the case of the other drawings. To simplify the presentation, the inverted pantograph in FIG. 3 has been illustrated here without one of the side walls of a housing of the actuator 2. The telescopic shaft 4 arranged in the rest position inside the housing can consequently be seen. A cable guide 16 can also be seen which is composed of links which can pivot relative to one another, and on which cables 17 are guided for conducting electrical power and control signals to the contact rails 7 of the contact head 6. The cable guide 16 can follow movements of the telescopic shaft 4 and thus compensate a change in height of the contact head 6. If the contact head 6 is lowered from the rest position illustrated in FIG. 3 into the charging position, the cable guide 16 extends downward out of the housing of the actuator 2. If the contact head 6 is raised again into the rest position, the cable guide 16 is raised back into the housing in a bending movement such that it ultimately reassumes the upside-down U-shape shown.

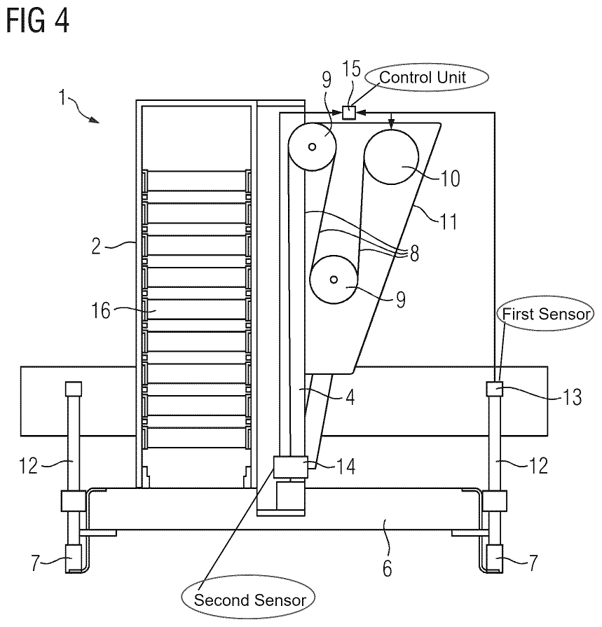

FIG. 4 shows a third exemplary embodiment of an inverted pantograph 1 according to the invention which corresponds structurally at least largely to the example of FIG. 3. The exemplary embodiment of FIG. 4 thus also has a cable guide 16 as has been described above. The actuator 2 of the inverted pantograph 1 of FIG. 4 is equipped with a cable drive 11 which is configured by way of example with pulleys 9 and a cable 8, for example a wire cable. An electric motor 10 which is designed to wind the cable 8 onto a spindle or unwind it therefrom in order to move the contact head 6 between the rest position and the charging position serves here as the actual drive. Configurations of a cable drive other than the one illustrated can of course be chosen. The term “cable” is here also not necessarily to be understood as a cable in the literal sense and belts or chains can also be used.

In each case a first sensor 13 and a second sensor 14 are arranged on the contact head 6 of the inverted pantograph of FIG. 4, wherein the first sensor 13 is arranged on one of the spring-loaded bearings 12. A plurality of first sensors 13 can also be provided, for example one on each spring-loaded bearing 12.

The first sensor 13 serves to measure directly or indirectly a force acting on the spring-loaded bearing 12 and to output a measurement signal representing this force to a control unit 15. The control unit 15 can be arranged at any point and does not have to be situated at the attachment location of the actuator 2. A remote arrangement of the control unit 15, for example in a server, is also possible. For this reason, the illustration of the control unit and the signal lines connected thereto is also to be understood as purely schematic.

The control unit 15 can use the measurement signal received from the first sensor 13 to detect that the contact head 6 is sitting on the mating contact arrangement of the electric vehicle, whereupon the control unit 15 can stop the electric motor 10 of the cable drive 11 in order to not unwind the cable 8 unnecessarily.

The inverted pantograph 1 of the exemplary embodiment in FIG. 4 is also equipped with a second sensor 14 which can be arranged, for example, between the cable 8 and the contact head 6 and is designed to measure directly or indirectly a tensile force acting on the cable drive 11 and to communicate a measurement signal representing the measured tensile force to the control unit 15. The control unit 15 can use the measurement signal received from the second sensor 14 to stop the electric motor 10 of the cable drive 11 when the measurement signal indicates that the tensile force on the cable 8 has risen above a specified amount. This can be the case, for example, when the rest position is reached or when the measurement head 6 has jammed. In the latter case, the control unit 15 can output a fault signal in order to draw attention to this fault.

The sensors 13 and 14 can measure the said measured values in different ways. Thus, the tensile force acting on the cable 8 can also be effected on the basis of measurement of the drive current flowing into the electric motor 10 such that the second sensor 14 is configured as a current sensor. The first sensor 12 can equally indicate relaxation or tensioning of springs of the spring-loaded bearing 12, wherein the control unit 15 accordingly evaluates the signal in a different fashion.

The invention has been explained in detail on the basis of exemplary embodiments. The exemplary embodiments here serve only for a better understanding of the invention and are not intended to restrict the invention which is defined exclusively by the following claims.

### LIST OF REFERENCE SIGNS

1 inverted pantograph
2 actuator
3 suspension means
4 telescopic shaft
5 sub-shaft
6 contact head
7 contact rail
8 cable
9 pulley
10 electric motor
11 cable drive
12 spring-loaded bearing
13 first sensor
14 second sensor
15 control unit
16 cable guide
17 cable

1-9. (canceled)

10. An inverted pantograph for a charging device for an electric vehicle, the inverted pantograph comprising:
an actuator having first and second mutually opposite ends, a suspension device at said first end and a contact head at said second end for contacting the electric vehicle;
said actuator configured to lower said contact head from a rest position into a charging position for charging the electric vehicle, to exert a contact pressure on said contact head in said charging position, and to raise said contact head into said rest position after a charging procedure;
said actuator including a telescopic shaft having at least two sub-shafts configured to be pushed axially into each other.

11. The inverted pantograph according to claim 10, wherein the contact pressure is effected by a weight force of said contact head and at least one of said sub-shafts of said telescopic shaft.

12. The inverted pantograph according to claim 11, wherein the contact pressure is a difference between a counter force and the weight force of said contact head and said at least one sub-shaft of said telescopic shaft.

13. The inverted pantograph according to claim 10, wherein said actuator includes a control unit and a cable drive connected to said contact head, said cable drive configured to move said contact head, in response to control signals of said control unit, between said rest position and said charging position.

14. The inverted pantograph according to claim 13, wherein said cable drive has an electric motor.

15. The inverted pantograph according to claim 13, which further comprises:
a spring-loaded bearing connecting said contact head to said telescopic shaft; and
a first sensor configured to measure a first measured value dependent on a force acting on said spring-loaded bearing and to output the first measured value to said control unit as a first measurement signal;
said control unit configured to stop said cable drive when the first measurement signal exceeds a predetermined first threshold value.

16. The inverted pantograph according to claim 15, which further comprises:
a second sensor configured to measure a second measured value dependent on a tensile force acting on said cable drive and to output the second measured value to said control unit as a second measurement signal;
said control unit configured to stop said cable drive when the second measurement signal exceeds a predetermined second threshold value.

17. The inverted pantograph according to claim 13, which further comprises:
an energy accumulator connected to said control unit and to said cable drive;
said control unit configured to detect failure of a supply voltage and, upon a failure of the supply voltage being detected, to output a restoring control signal to said cable drive; and
said cable drive configured to raise said contact head into said rest position in response to the restoring control signal.

18. A charging device for charging an electric vehicle, the charging device comprising an inverted pantograph according to claim 10.
